(19) United States
(12) Patent Application Publication
(10) Pub. No.: US 2010/0177593 A1
(43) Pub. Date: Jul. 15, 2010

(54) Stirring Apparatus

(75) Inventor: Katsuhide Takenaka, Ehime (JP)

Correspondence Address: THE WEBB LAW FIRM, P.C., 700 KOPPERS BUILDING, 436 SEVENTH AVENUE, PITTSBURGH, PA, 15219, US

(73) Assignee: SHI MECHANICAL & EQUIPMENT INC., Saijo-shi, Ehime (JP)

(21) Appl. No.: 12/377,205

(22) PCT Filed: May 21, 2008
(86) PCT No.: PCT/JP2008/059330

§ 371 Date: Feb. 11, 2009

(30) Foreign Application Priority Data
May 30, 2007 (JP) 2007-143239

(51) Int. Cl. B01F 7/00

(52) U.S. Cl. 366/293

(57) ABSTRACT

An object is to provide a stirring apparatus which can exhibit excellent mixing characteristics and shorten the mixing time. The stirring apparatus includes a stirred tank having a bottomed cylindrical shape, a rotational shaft disposed coaxially or substantially coaxially within the stirred tank, a plate-shaped bottom blade having a lower end edge shaped to conform to a bottom wall surface of the stirred tank, the bottom blade having an opening for communication between one face side and an opposite face side, of the bottom blade, the ratio (h/d) between the blade height h of the bottom blade and the impeller diameter d of the bottom blade satisfies 0.4≦h/d, and the ratio of the opening area to the projection area of the bottom blade as viewed from the rotational direction thereof (opening ratio of the bottom blade) is 10-60%.

### TECHNICAL FIELD

The present invention relates to a stirring apparatus for performing a stirring treatment for the purpose of mixture, dissolution, crystallization, reaction, and the like.

### BACKGROUND ART

Hitherto, provided are various types of stirring apparatus for performing a stirring treatment for the purpose of mixture, dissolution, crystallization, reaction, and the like. As an example of them, there is known a stirring apparatus in which a bottom blade 153 is disposed in a lower area of a stirred tank 150 having a bottomed cylindrical shape, as illustrated in FIG. 6.

The bottom blade 153 is attached to a rotation shaft 152 disposed within the stirred tank 150 to be coaxial or substantially coaxial therewith to extend in radial and vertical directions of the stirred tank 150. The bottom blade 153 has basically a plate shape, while having a flat plate shape extending straight from the rotational shaft 152 in the radial direction, having a flat plate portion close to the rotational shaft 152 and a distal end portion bent in the rotation direction, or having a plate shape twisted from a proximal end close to the rotational shaft 152 to the distal end. In any shape, the lower end edge of each blade is shaped to conform to the bottom wall surface of the stirred tank 150 and disposed to be in proximity with the same.

In the stirring apparatus, since the bottom blade 153 is disposed in the lower area of the stirred tank 150, an object M to be stirred (or a stirring object) in the lower area of the stirred tank 150 is pumped (forced) in the radial direction of the stirred tank 150 through a front face of the rotating bottom blade 153 (one of the faces oriented in the rotational direction). Whereby, the stirring object M pumped out in the radial direction of the stirred tank 150 forms a circulation flow R, which collides with a peripheral wall 151 of the stirred tank 150, moves up to the vicinity of the liquid level, moves to the center of the stirred tank 150 in the vicinity of the liquid level, moves down at the center of the stirred tank 150, and again returns to the bottom blade 153.

The stirring apparatus having such a bottom blade 153 can exhibit excellent mixing characteristics in a wide flow region from a turbulent flow region to a streamline flow region by forming a large circulation flow R from the bottom of the stirred tank 150 to the liquid level as a whole.

### DISCLOSURE OF THE INVENTION

### Problem to be Solved by the Invention

As described above, the stirring apparatus having the above structure can carry out mixing in a wide flow region, but may not be able to completely mix the object in a short time. It is assumed that this is because the stirring object M is stagnated around the back face of the plate-shaped bottom blade 153 (another side opposite to the rotational direction) during rotation, and hence liquid exchange between the front face side and the back face side, of the bottom blade 153 is difficult to be made.

Accordingly, it is an object of the invention to provide a stirring apparatus which can exhibit excellent mixing characteristics and shorten the mixing time.

### Means for Solving the Problem

According to the present invention, there is provided a stirring apparatus that includes a stirred tank having a bottomed cylindrical shape, a rotational shaft disposed coaxially or substantially coaxially within the stirred tank, a bottom blade having a plate shape and a lower end edge shaped to conform to a bottom wall surface of the stirred tank, the bottom blade having an opening for communication between one face side and an opposite face side, of the bottom blade, the ratio (h/d) between the blade height h of the bottom blade and the blade diameter d of the bottom blade satisfies 0.4≦h/d, and the ratio of the opening area to the projection area of the bottom blade as viewed from the rotational direction thereof (opening ratio of the bottom blade) is 10-60%.

According to the stirring apparatus of the above structure, when the bottom blade is rotated about the rotational shaft, a stirring object on the front face side of the bottom blade is pumped in the radial direction of the stirred tank, collides with the peripheral wall of the stirred tank and thus forms a large circulation flow within the stirred tank.

The opening for communication between the front face side and the back face side, of the bottom blade allows the stirring object located in a area corresponding to the opening to move to the back face side of the bottom blade while passing through the opening when the stirring object is pumped by the bottom blade in the manner mentioned above. Whereby, the stirring object, which has moved to the back face side of the bottom blade, is dispersed in the back face side of the bottom blade along with the stirred object stayed in the back face side of the bottom blade and is pumped in the radial direction by the front face of the following bottom blade. As a result, the stirring object is mixed along a circulation flow within the stirred tank.

In the stirring apparatus, by appropriately setting the relationship of the impeller diameter and the blade height to the opening ratio, of the bottom blade, stirring can be well made, with the result that the mixing time can be shortened. This effect was confirmed by experiments.

As one embodiment of the present invention, it is preferable to employ an arrangement, in which the opening is formed to have upper and lower sides formed in straight line while being parallel to an upper end edge of the bottom blade, and have opposite lateral sides formed in straight line while being parallel to a lateral end edge of the bottom blade, in which the distance from the upper end edge of the bottom blade to the upper side of the opening and the distance from the lateral end edge of the bottom blade to the corresponding lateral side of the opening are set at the same distance b while satisfying 0.04d≦b≦0.11d with reference to the impeller diameter d. This setting enables better stirring. This effect was confirmed by an experiment, too.

### ADVANTAGE OF THE INVENTION

According to the present invention described above, it is possible to produce excellent advantageous effects, such as exhibiting excellent mixing characteristics and thus to shorten the mixing time.

### BRIEF DESCRIPTION OF THE DRAWINGS

FIG. 1 is a schematic cross sectional view of a stirring apparatus according to an embodiment of the present invention.

FIG. 2 is an explanatory view for explaining the flow of a stirring object in the stirring apparatus of the aforesaid embodiment.

FIG. 3 is a schematic cross sectional view of the stirring apparatus according to first and second examples of the present invention.

FIG. 4 is a graph showing the relationship between h/d for each of the opening ratios and the mixing performance (mixing time), of the first example.

FIG. 5 is a graph showing the relationship between each of the different positions of the opening and the mixing performance (mixing time), of the second example.

FIG. 6 is a schematic cross sectional view of a conventional stirring apparatus.

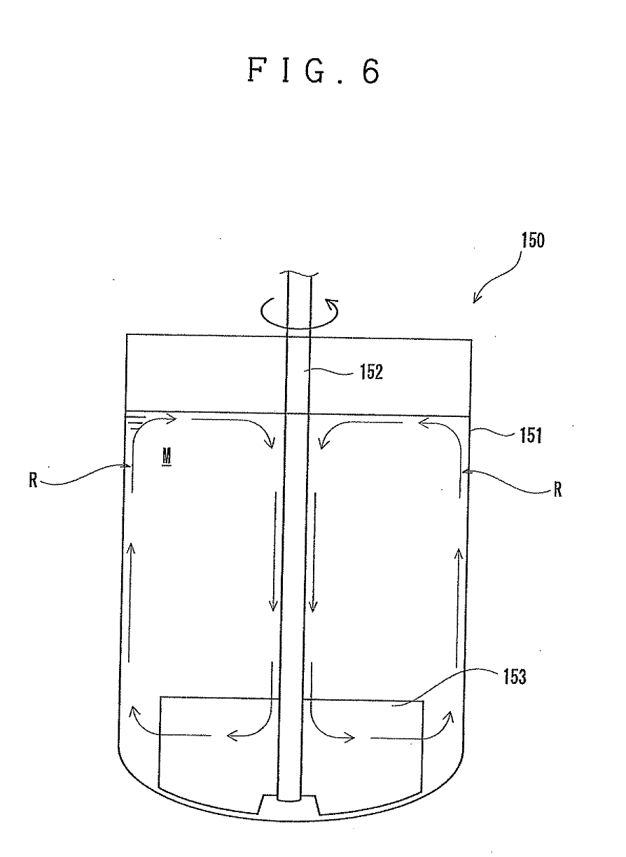

### DESCRIPTION OF THE REFERENCE NUMERALS

1: stirred tank, 2: rotational shaft, 3: stirring impeller, 10: peripheral wall, 11: peripheral wall surface, 12: bottom, 13: bottom wall surface, 30: bottom blade, 30a, 30b: pumping areas, 31: lattice blade, 300: opening, 310: arm, 311: strip, b: distance, D: tank diameter (inner diameter of the peripheral wall), d: impeller diameter, e1: upper edge, e2: lower edge, e3, e4: side edges, E1: upper end edge, E2: lateral end edge, h: blade height, M: stirring object, R: vertical circulation flow

### PREFERRED EMBODIMENTS FOR CARRYING OUT THE INVENTION

Now, the description will be made for a stirring apparatus of an embodiment of the present invention with reference to the attached drawings.

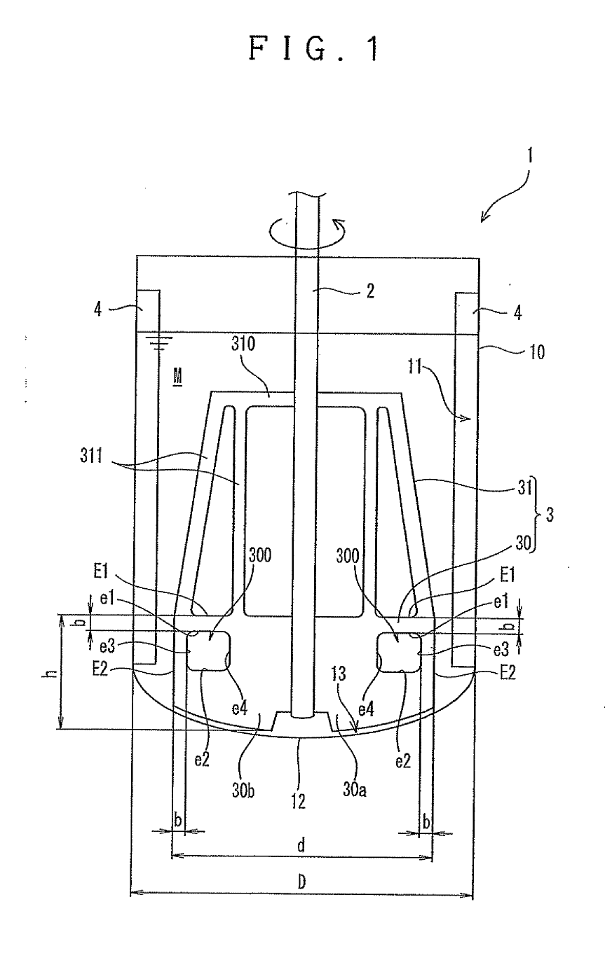

As illustrated in FIG. 1, the stirring apparatus of this embodiment includes a stirred tank 1 having a bottomed cylindrical shape, a rotational shaft 2 disposed at the center or substantially at the center of the stirred tank 1, and a stirring impeller 3 attached to the rotational shaft 2.

The stirred tank 1 has a cylindrical peripheral wall 10, and a bottom 12 (bottom wall surface 13) having a substantially circular cross section (semi-circular shape).

The rotational shaft 2 is disposed to have an upper end projecting outward away from the top of the stirred tank 1 and a lower end vertically extending to the vicinity of the bottom wall surface 13. This projecting upper end is connected to a driving unit (not illustrated) outside of the stirred tank 1 via a coupling (not illustrated). The rotational shaft 2 may be supported at the upper end side of the stirred tank 1, while it may be supported at the lower end side thereof via a bearing (not illustrated) provided at a center portion of the bottom wall surface 13 of the stirred tank 1. The driving unit for driving the rotational shaft 2 may be provided not on the upper side of the stirred tank 1 but on the side of the bottom 12 of the stirred tank 1.

The stirring impeller 3 includes a bottom blade 30 disposed in the lower area within the stirred tank 1. In addition to the bottom blade 30, the stirring impeller 3 of this embodiment further includes a lattice blade 31 disposed above the bottom blade 30.

The bottom blade 30 is connected to the rotational shaft 2 to extend radially and vertically within the stirred tank 1. The bottom blade 30 of this embodiment is of a flat plate shape and is disposed to extend in the opposite directions from the rotational shaft 2 along the axis of the rotational shaft 2. Specifically, the bottom blade 30 is made up of two pumping areas 30a, 30b symmetrically arranged about the rotational shaft 2, and a front face of the pumping area 30a and a front face of the pumping area 30b, which act to pump a stirring object M when they rotate about the rotational shaft 2, are located opposite to each other in the thickness direction of the bottom blade 30. In other words, the bottom blade 30 pumps a stirring object M in the same direction by the symmetrically arranged two pumping areas 30a, 30b by the rotation about the rotational shaft 2.

The bottom blade 30 is shaped to have the lower edge conforming to the bottom wall surface 13, and has a clearance to the bottom wall surface 13 to such an extent as not to cause sliding contact with the bottom wall surface 13 of the stirred tank 1 during rotation (stirring). In this embodiment, as described above, the bottom 12 (bottom wall surface 13) of the stirred tank 1 has a substantially circular cross section (semi-circular shape), and therefore the lower end edge of the bottom blade 30 has a substantially circular shape (elliptical shape) corresponding to the bottom wall surface 13.

The bottom blade 30 is formed to have the ratio (h/d) between the vertical height (blade height) h and the rotational diameter (impeller diameter) d satisfying 0.4≦h/d. Also, the ratio of the impeller diameter d of the bottom blade 30 and the inner diameter (tank diameter) D of the peripheral wall 10 of the stirred tank 1 of this embodiment is set at 0.4<d/D<0.8 and more preferably 0.4≦d/D≦0.7.

The bottom blade 30 of this embodiment has openings 300 for communication between one face side (front face side located upstream side of the rotational direction) and an opposite face side (back face side located downstream of the rotational direction).

The openings 300 are formed respectively in the two symmetrical pumping areas 30a, 30b of the bottom blade 30 to be symmetrical with reference to the rotational shaft 2. In this embodiment, the openings 300 each have a substantially rectangular shape, in which an upper edge (upper side) e1 and a lower edge (lower side) e2 extend straight to be substantially parallel to an upper end edge E1 of the bottom blade 30, and both lateral edges (both lateral sides) e3, e4 extend straight to be substantially orthogonal to the upper edge e1 and the lower edge e2 and substantially parallel to the lateral end edge E2 of the bottom blade 30.

The openings 300 each are formed so that the ratio of the opening area (opening ratio) to the projecting area as viewed from the rotational direction of the respective pimping areas 30a, 30b is 10%-60%. Accordingly, the ratio of the total opening area of the two openings 300 to the projection area of the entire bottom blade 30 is also 10%-60%.

The openings 300 each are formed so that the distance from the upper end edge E1 of the bottom blade 30 (the respective pumping areas 30a, 30b) to the upper edge e1 of each opening 300 and the distance from the lateral end edge E2 of the bottom blade 30 (the respective pumping areas 30a, 30b) to the lateral edge e3 of the opening 300 on the side of the lateral end edge E are set to be the same distance b. This distance b is set to be 0.04d≦b≦0.11d with reference to the impeller diameter d. That is, the ratio between the distance b from the upper end edge E1 of the bottom blade 30 to the upper edge e1 of the opening 300 and the distance b from the lateral end edge E2 of the bottom blade 30 to the lateral edge e3 of the opening 300, and the impeller diameter d is set to be 0.04≦b/d≦0.11.

The lattice blade 31 is made up of arms 310 extending in the lateral direction (radial direction), and strips 311 extending in the vertical direction, and the arms 310 and the strips 311 each are formed into band plate shape. The lattice blade 31 of this embodiment is formed by a single arm 310 and four strips 311, in which the upper ends of the respective strips 311 are connected to the arm 310, and the lower ends of the respective strips 311 are connected to the upper end of the bottom blade 30. Whereby, the stirring impeller 3 of this embodiment is composed of an integral arrangement of the bottom blade 30 and the lattice blade 31. Two of the four strips 311, which are radially outwardly located, are disposed to come closer to each other as they advance upward. That is, the two outer strips 311 are inclined to come closer to the rotational shaft 2 as they advance upward.

The stirring apparatus of this embodiment having the above structure includes at least one baffle 4 within the stirred tank 1 in order to enhance the stirring performance for a stirring object M. The baffle 4 is secured to the peripheral wall 10 of the stirred tank 1 and disposed between the peripheral wall 10 and the rotational area of the stirring impeller 3. Employed for baffles of this embodiment are plural (e.g., four) plate baffles 4 each having a plate shape that are secured to the peripheral wall 10 of the stirred tank 1 and disposed with a distance from each other in the circumferential direction.

Now the description will be made for the stirring performance of the stirring apparatus of this embodiment having the above structure.

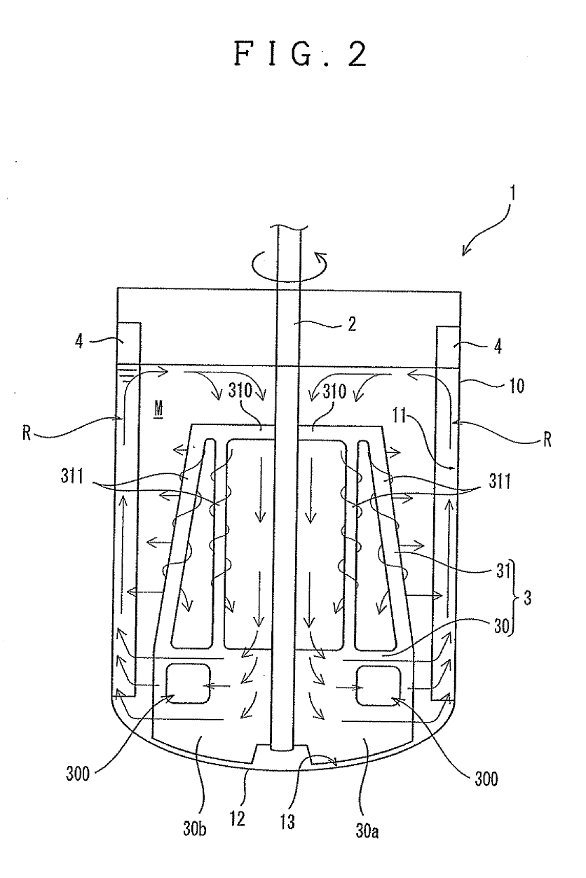

As illustrated in FIG. 2, by the rotation of the stirring impeller 3, a stirring object M within the stirred tank 1 is pumped outward in the radial direction by the front face (substantial part) of the bottom blade 30 (pumping areas 30a, 30b) so that the stirring object M within areas corresponding to the openings 300 is elongated towards the back side of the bottom blade 30 (or is formed into a continuous shape extending over the front and back of the bottom blade 30) as it moves through the openings 300, and then collides with the front face of the following bottom blade 30 (pumping areas 30a, 30b), thereby causing its elongated shape to be drawn into a folded shape, so that mixing is promoted while the object to be stirred is radially pumped towards the peripheral wall 10.

In this embodiment, the baffles 4 provided within the stirred tank 1 shear the radially outwardly pumped stirring object M when the stirring impeller 3 (bottom blades 30) rotates and passes through positions corresponding to the baffles 4. Thus, mixing can be promoted by this.

At the same time of the pumping action of the bottom blade 30 (pumping areas 30a, 30b), the stirring object M located in the vicinity of the bottom wall surface 13 of the stirred tank 1 is scraped by the lower end of each bottom blade 30 while this scraped stirring object M is also radially outwardly pumped.

The stirring object M pumped by these bottom blades 30 collides with the peripheral wall 10 and then moves upwards along a peripheral wall surface 11. At this moment, the upwardly moving stirring object M moves upwards along the peripheral wall surface 11 while being pressed against the peripheral wall 10 through the stirring object M pumped by the strips 311 rotated about the rotational shaft 2.

The stirring object M moves up to the vicinity of the liquid level, moves to the center of the stirred tank 1 (rotational shaft 2), and then starts moving downwards from the vicinity of the rotational shaft 2 and the uppermost arms 310 of the lattice blade 31. Then, the stirring object M returns to the bottom blades 30, thus forming a large vertical circulation flow R. The openings 300 provided in the bottom blades 3 of the stirring apparatus of this embodiment accelerates a downward flow in the vicinity of the rotational shaft 2, with the result that a large vertical circulation flow developed in the stirred tank 1 is formed and thus mixing is promoted.

A downward flow of the stirring object M in this vertical circulation flow R is sheared into small segments by the strips 311. The small segments of the sheared downward flow are sucked into micro vortices generated in the back sides of the arms 310 and the strips 311 so that the stirring of the stirring object M proceeds. At the same time, the arms 310 and the strips 311 act to pump radially outwardly the stirring object M and therefore act to press an upward flow of the stirring object M moving upward along the peripheral wall surface 11 towards the peripheral wall surface 11. The outer strips 311 each have a distance increased from the rotational shaft 2 as they advance to the downside, and therefore the flow speed of the discharged stirring object M increases towards the lower side. Accordingly, this synergistic effect enables the stirring object M to be more efficiently stirred.

As described above, according to the stirring apparatus of this embodiment, the bottom blades 30 respectively have the openings 300, and the bottom blades 30 and the openings 300 are properly sized or dimensioned, so that high stirring performance can be exhibited and thus the time for mixing can be shortened. In addition, when the bottom blades 30 have the openings 300, excessive pumping action is not caused to the stirring object M in the opening areas and therefore a satisfactory mixing effect can be produced by a low power.

### Example 1

The present inventors performed the experiments under the following experimental conditions to confirm a preferable manner as to how to set the opening ratio of the opening 300 formed in each bottom blade 30. In this experiment, in order to confirm the mixing performance of only the bottom blades 30, a stirring apparatus is provided, which includes only the bottom blades 30 as the stirring impeller 3 and the baffles 4 within the stirred tank 1.

<Experimental Condition 1>
Tank diameter D: 310 mm
Impeller diameter d: 217 mm
Blade height h: 45 mm-320 mm
Opening ratio of bottom blade 30: 8%-70%
Baffles: present (four baffles each having a vertical length (dimension from the liquid level to the downstream side) of 310 mm and a lateral length of 24.8 mm are disposed as baffles with a distance from each other in the circumferential direction)
Fluid volume: 27.3 litters
Fluid type: water
Viscosity: 1 cp
Specific power: 0.1 kw/m³

<Experiment Procedure 1>

By the use of the iodine reduction decolorization technique, the mixing time from the start of mixing to the time at which a stagnated portion (unstirred area) has disappeared is measured. Specifically, after liquid within the stirred tank 1 is colored in burned sienna by iodine, then a decolorizing solution is put thereinto, the progress of decolorization is observed by stirring, and the time up to the completion of the decolorization is measured. This procedure is a well known procedure disclosed in, for example, Mixing (1975) Shinji NAGATA John Wiley & Sons, P187, 4.3.1 Method of Measuring Mixer Performance, and Handbook of Industrial Mixing, John Wiley & Suns, P167, 4-4.3 Approximate Mixing Time Measurement with Calorimetric methods.

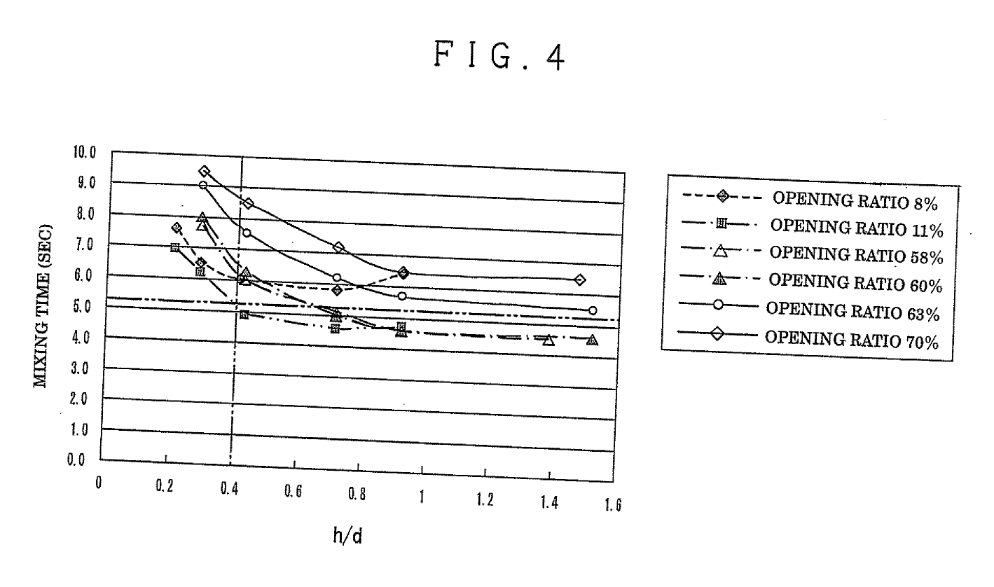

Based on the Experimental condition 1 and the Experiment procedure 1, an experiment was performed by using a bottom blade 30 having a different opening ratio of the opening 300. As shown in FIG. 4, it is found that when the ratio (h/d) between the blade height h of the bottom blade 30 and the impeller diameter d of the bottom blade 30 is 0.4≦h/d and the ratio of the opening area (opening ratio) of the opening 300 to the projection area of the bottom blade 30 as viewed from the rotational direction thereof is 10-60%, the stirring is completed in a short time. Specifically, it is found that when the ratio (h/d) between the blade height h of the bottom blade 30 and the impeller diameter d of the bottom blade 30 is 0.4>h/d, the mixing time is prolonged, and when the opening ratio is less than 10% or the opening ratio exceeds 60%, the mixing time tends to be prolonged.

### Example 2

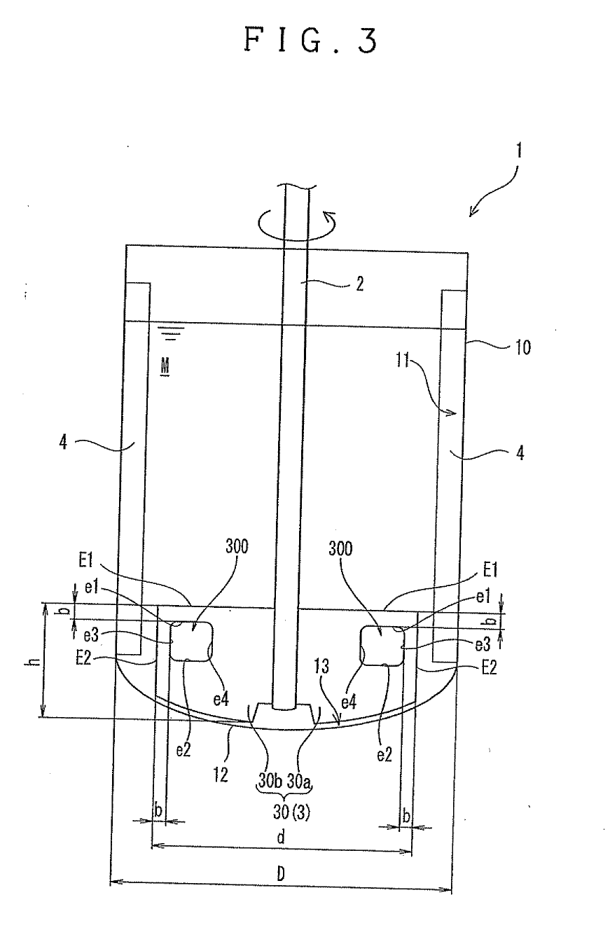

In addition to the aforesaid experiment, the present inventors performed an experiment to confirm a preferable manner as to how to set the position of the opening 300. Also, in this experiment, the experiment was made for the stirring apparatus of FIG. 3, in the same manner as Example 1.

<Experimental Condition 2>
Tank diameter D: 310 mm
Impeller diameter d: 217 mm
Blade height h: 89 mm
Ratio (h/d) between the impeller diameter d and the blade height h: 0.41
Distance b from the upper end edge E1 of the bottom blade 30 to the upper edge e1 of the opening 300=distance from the lateral end edge E2 of the bottom blade 30 to the lateral edge e3 of the opening 300: 0 mm-50 mm
Opening ratio of the bottom blade 30: 10%
Baffles: present (four baffles each having a vertical length (dimension from the liquid level to the downstream side) of 310 mm and a lateral length of 24.8 mm are disposed as baffles with a distance from each other in the circumferential direction)
Fluid volume: 27.3 litters
Fluid type: water
Viscosity: 1 cp
Specific power: 0.1 kw/m³

<Experiment Procedure 2>

By the use of the iodine reduction decolorization technique in the same manner as Example 1, the mixing time from the start of mixing to the time at which a stagnated portion (unstirred area) has disappeared is measured.

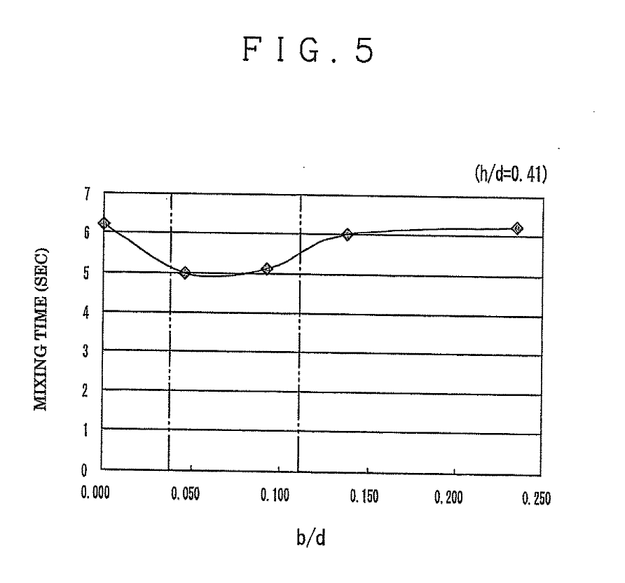

Based on the Experimental condition 2 and the Experiment procedure 2, an experiment was performed by using a bottom blade 30 having an opening 300 formed at a different position (distance b from the upper end edge E1 of the bottom blade 30 to the upper edge e1 of the opening 300, and distance b from the lateral end edge E2 of the bottom blade 30 to the lateral edge e2 of the opening 300). As shown in FIG. 5, it is found that when the ratio (b/d) between the position b of the opening 300 and the impeller diameter d satisfies 0.04≦b/d≦0.11, the mixing is completed in a short time. Specifically, it is found that when the ratio (b/d) between the position b of the opening 300 and the impeller diameter d satisfies b/d<0.04, the mixing time is prolonged; and when 0.11<b/d, the mixing time tends to be prolonged. In this embodiment, the ratio (h/d) between the impeller diameter d and the blade height h is 0.41, and even if this ratio is changed, it is assumed that the same tendency as that of the above Example can be demonstrated, since the position of the opening 300 (distance b from the upper end edge E1 of the bottom blade 30 to the upper edge e1 of the opening 300, and distance b between the lateral end edge E2 of the bottom blade 30 and the lateral edge e2 of the opening 300) is determined with reference to the impeller diameter d of the bottom blade 30.

The present invention is not limited to the above embodiment, and it is a matter of course that various modifications can be made without departing the scope of the present invention.

In the above embodiment, the bottom blade 30 and the lattice blade 31 are formed integrally with each other without intention to limit the present invention thereto. For example, the bottom blade 30 and the lattice blade 31 may be formed separately from each other by different members or parts and connected together to form the stirring impeller 3. In this case, the bottom blade 30 and the lattice blade 31 may be disposed close to each other, or the bottom blade 30 and the lattice blade 31 may be disposed separately from each other with a slight clearance therebetween.

In the above embodiment, the stirring impeller 3 formed by the combination of the bottom blade 30 and the lattice blade 31 is employed without intention to limit the present invention thereto. For example, as in the above example, the stirring impeller 3 may be formed only by the bottom blade 30, or in place of the lattice blade 31, a blade having a different shape (e.g., a turbine blade, an anchor blade or a propeller) may be combined with the bottom blade 30, thereby forming the stirring impeller 3.

In the above embodiment, the baffles are provided within the stirred tank 1 without intention to limit the present invention thereto. For example, the stirring impeller 3 may be only mounted within the stirred tank 1 without providing any baffle 4. With this arrangement, too, it is apparent that the same function and effect as those of the above Examples can be produced by appropriately setting the size or dimension of each of the bottom blade 30 and the opening 300.

In the above embodiment, the position of the opening 300 is determined with reference to the impeller diameter d without intention to limit the present invention thereto. The mixing can be completed in a short time, as long as the ratio (h/d) between the blade height h of the bottom blade and the impeller diameter d of the bottom blade is 0.4≦h/d, and the ratio of the opening area of the opening to the projection area of the bottom blade as viewed from the rotational direction thereof is 10-60%. For better mixing, in the same manner as that of the above embodiment, it is a matter of course that it is preferable that the distance from the upper end edge E1 of the bottom blade 30 to the upper edge e1 and the distance from the lateral end edge E2 of the bottom blade 30 to the lateral edge e3 on the side of the lateral end edge E2 are set at the same distance b, and this distance b is set at 0.04d≦b≦0.11d.

In the above embodiment, the bottom blade 30 having a flat plate shape is employed as the bottom blade 30 without intention to limit the present invention thereto. For example, it is possible that the bottom blade 30 has its side close to the rotational shaft 2 formed into a flat shape and a distal end portion bent in the rotational direction, or has a twisted flat plate shape extending from the side close to the rotational shaft 2 to the distal end. That is, various shapes are possible, as long as the bottom blade 30 has a lower end edge shaped to conform to the bottom wall surface 13 of the stirred tank 1 and rotates about the rotational shaft 2 that is coaxial or substantially coaxial with the stirred tank 1.

1. A stirring apparatus comprising a stirred tank having a bottomed cylindrical shape, a rotational shaft disposed coaxially or substantially coaxially within the stirred tank, a bottom blade having a plate shape and a lower end edge shaped to conform to a bottom wall surface of the stirred tank, the bottom blade having an opening for communication between one face side and an opposite face side, of the bottom blade, the ratio (h/d) between the blade height h of the bottom blade and the impeller diameter d of the bottom blade satisfies 0.4≦h/d, and the ratio of the opening area to the projection area of the bottom blade as viewed from the rotational direction thereof (opening ratio of the bottom blade) is 10-60%.

2. The stirring apparatus according to claim 1,
wherein the opening is formed to have upper and lower sides formed in straight line while being parallel to an upper end edge of the bottom blade, and have opposite lateral sides formed in straight line while being parallel to a lateral end edge of the bottom blade, in which the distance from the upper end edge of the bottom blade to the upper side of the opening and the distance from the lateral end edge of the bottom blade to the corresponding lateral side of the opening are set at the same distance b while satisfying 0.04d≦b≦0.11d with reference to the impeller diameter d.
